(19) United States
(12) Patent Application Publication
(10) Pub. No.: US 2023/0361298 A1
(43) Pub. Date: Nov. 9, 2023

(54) CARBON FELT BASED ELECTRODES ASSEMBLY AND A METHOD OF MANUFACTURING THE SAME

(71) Applicant: LOG 9 MATERIALS SCIENTIFIC PRIVATE LIMITED, BENGALURU (IN)

(72) Inventors: AKSHAY VIVEK SINGHAL, DEOBAND (IN); ANSHUL KUMAR SHARMA, KANGRA (IN); KUNAL PAUL, KOLKATA (IN); ARVIND BHARDWAJ, JAIPUR (IN); SYED SHAJAR ALI MAM, DIBRUGARH (IN); HEMANT CHARAYA, HISAR (IN)

(21) Appl. No.: 17/528,130

(22) PCT Filed: May 14, 2020
(86) PCT No.: PCT/IN2020/050436

§ 371 Date: Nov. 16, 2021

(30) Foreign Application Priority Data
May 16, 2019 (IN) 201811043134

(51) Int. Cl. H01M 4/583; H01M 4/04; H01M 4/62

(52) U.S. Cl. CPC H01M 4/583; H01M 4/0404; H01M 4/622; H01M 4/0435

(57) ABSTRACT

The various embodiments of the present invention provide a method of fabricating carbon felt based electrodes without any binder additive. A coating of conductive polymer adhesives is applied on the current collector. The carbon felts are placed on either side of the current collector to get an assembly. The assembly comprising current collector and carbon felt is placed between the plates of hot press with predetermined conditions for curing the adhesive applied on the surface of current collector and to obtain sandwich structure of electrode. The sandwich structure of electrode is subjected under a roller and pressed depending on required thickness and porosity of the electrodes. The electrodes are cut into desired shape using electrode cutting die in tailoring process. The prepared carbon felt based electrode illustrates high flexibility and mechanical robustness when compared to carbon felt electrodes that are binder based and brittle in nature.

### CROSS-REFERENCE TO RELATED APPLICATIONS

The present application is a National Phase Application of the PCT application with the serial number PCT/IN2020/050436 filed on May 14, 2020, with the title, “CARBON FELT BASED ELECTRODES ASSEMBLY AND A METHOD OF MANUFACTURING THE SAME”. The present application claims the priority of Indian Provisional Patent Application with serial number No. 201811043134, filed on Nov. 16, 2018, and subsequently Post-dated by 6 months to May 16, 2019, with the title, “Assembly of Carbon Felt Based Electrodes and Preparation Method Thereof”, and the content of which is incorporated herein by reference in its entirety. The present application further incorporates the contents of Indian Provisional Patent Application with serial number 201811043051, filed on Nov. 15, 2018, with the title. “Methods for The Preparation of Graphene Felts”, by reference herein in its entirety.

### BACKGROUND

### Technical Field

The embodiments of the present invention are generally related to electrode assembly. The embodiments of the present invention are particularly related to a carbon felt based electrodes for electrochemical applications such as fuel cells, super capacitor, metal air battery, metal-ion battery, redox flow battery, etc. The embodiments of the present invention are more particularly related to a carbon felt based electrode structure or composition and a method of fabricating flexible, free-standing, and mechanically robust carbon felt based electrodes with enhanced current collection ability.

### Description of the Related Art

For any energy storage technology, electrode material is a vital component as it has direct impact on the energy and power density. A suitable and competent electrode material should possess good electrical conductivity, high specific surface area, excellent electrochemical activity and low cost. Conventional metallic electrodes have poor electrochemical reversibility and get easily passivated/unreactive by electrolyte media. Though, precious metals-based electrodes that contains platinum, iridium, selenium, zirconium and ruthenium, have high electrochemical activity, good catalytic properties and good chemical stability but these materials have restricted large scale application due to very high cost.

The present form of carbon felt electrodes, that are generally used for electrochemical application, suffer from poor mechanical stability as they are fragile and brittle, high resistivity which translates into high ohmic losses and poor wettability which results into inadequate electrochemical activity.

To achieve large scale application along with cost effectiveness, there exists a need to produce electrodes that have high conductivity, high specific surface area, good electrochemical stability and stability under strong acidic/basic conditions (sulfuric acid, sodium/potassium hydroxide supporting electrolytes) and which are produced on a large scale Specifically, carbon felts are chosen as the most widely used electrode materials because of high conductivity, high specific surface area, good electrochemical stability and stability under strong acidic/basic conditions (sulfuric acid, sodium/potassium hydroxide supporting electrolytes). Various carbon powders are mixed with polymer binder materials to obtain these carbon-felt electrode materials. But these polymeric binders actually have negative impact on the electrocatalytic property, conductivity and current collection ability of the carbon-based materials drastically.

Carbon felts electrodes based on polymeric organic/inorganic binder formed by carbonization of carbonaceous woven fabric are often found to be brittle in nature. When carbon felt electrodes made by these brittle carbon felts are assembled into a fuel cell or metal air battery or redox flow battery, numerous problems arises such as leakage and degradation of electrode due to less flexibility and low mechanical stability.

Modification and alteration of these carbon felt supported electrodes is a highly desired area of research in order to improve their electrochemical and catalytic activity and their utilization for various energy storage applications such as fuel cell, supercapacitor, metal air battery, metal-ion battery and redox flow batteries etc.

Hence there is a need for a method to fabricate carbon felt based electrodes without any binder additive. Further there is a need to fabricate carbon felt based electrodes which are flexible, mechanically robust and illustrate excellent current collection ability compared to other commercially available carbon felts. Still further there is need for carbon felt based electrode with high surface area, tunable pore structure and surface morphology and electrochemical activity. Also there is a need for carbon felt based electrodes in energy storage applications such as metal air battery, fuel cells, redox flow batteries and super capacitors.

The above-mentioned shortcomings, disadvantages and problems are addressed herein, which will be understood by studying the following specifications.

### OBJECTIVES OF THE EMBODIMENTS

The primary objective of the embodiment herein is to provide fabricate carbon felt based electrode composition or a carbon felt based electrode assembly structure and a method for fabricating the carbon felt based electrodes for electrochemical applications such as fuel cells, supercapacitor, metal air battery, metal-ion battery, redox flow battery, etc.

Another objective of the embodiment herein is to provide a method to fabricate carbon felt based electrodes from a plurality of carbon-based materials selected from a group consisting of a carbon foam, expanded graphite, exfoliated graphite, graphene foam, Graphene 3D architecture, 3D graphene, graphene sheets, graphene platelets, activated carbon, single and multi-walled carbon nanotubes, carbon black and their derivatives.

Yet another objective of the embodiment herein is to provide a method of fabricating carbon felt based electrodes without any binder additive.

Yet another object of the embodiment herein is to provide a carbon felt based electrodes assembly structure that is flexible and mechanically robust.

Yet another object of the embodiment herein is to provide a carbon felt based electrodes assembly having enhanced current collection ability.

Yet another object of the embodiment herein is to provide a carbon felt based electrodes assembly comprising a strong bond formed between carbon felts and various forms of current collectors such as metallic mesh, metallic screen, metallic foil, metallic foam, perforated metallic sheet, and non-woven metal fiber and conducting polymers.

Yet another object of the embodiment herein is to provide a carbon felt based electrodes assembly structure comprising a strong bonding between carbon felts and metallic current collectors selected from a group consisting of Al, Ag, Ni, Au, Fe or Pt.

Yet another object of the embodiment herein is to provide an electrically conductive adhesive to improve a current collection capability of carbon felt based electrodes and wherein the adhesive is selected from a group consisting of graphene-based adhesives, CNT-based adhesives, carbon-black based adhesives, silver paste, electrically conductive epoxy, metal-nan oparticles based adhesives and combination thereof.

Yet another object of the embodiment herein is to provide a processing technique to fabricate said carbon felt based electrodes assembly in which the current collector is sandwiched between two carbon felts.

Yet another object of the embodiment herein is to provide a processing technique to fabricate said carbon felt based electrodes assembly and wherein the processing technique is selected from a group consisting of hot pressing, cold pressing, and hydraulic compression.

Yet another object of the embodiment herein is to provide a rolling process for the fabrication of the carbon felt based electrode, which includes but not limited to hot rolling, cold rolling using two high rolling mills, three high rolling mills and two reversible rolling mills.

Yet another object of the embodiment herein is to provide a carbon felt based electrodes assembly in which a thickness of carbon felts-based electrodes assembly is optimized to be in a range of 0.4 mm-5 mm by rolling processes.

Yet another object of the embodiment herein is to provide a carbon felt based electrodes assembly in which a porosity of carbon felts-based electrodes is optimized to be in a range of 5-150 μm by rolling process.

Yet another object of the embodiment herein is to provide a carbon felt based electrodes assembly in which a density of carbon felt based electrodes is optimized in a range of 0.3 g/cm³-2 g/cm³ by rolling process.

Yet another object of the embodiment herein is to provide carbon felt based electrodes with a tunable surface morphology.

Yet another object of the embodiment herein is to provide a tailoring process for a carbon felt based electrodes assembly to provide a desired shape to the said carbon felts-based electrode.

These and other objects and advantages of the present invention will become readily apparent from the following detailed description taken in conjunction with the accompanying drawings.

### SUMMARY

The various embodiments herein provide carbon felts-based electrode assembly in which a metal current collector is incorporated between two carbon felts for mechanical support. The embodiments of the present invention provide a method for fabricating carbon felts based electrodes assembly with a capacity to with stand the high pressure, improved current collection efficiency of the electrodes and thereby reducing a fraction of energy lost in a form of ohmic losses. The embodiments herein also provide a method of fabricating carbon felt based electrodes without any binder additive.

According to one embodiment herein, a method of fabricating carbon felt based electrodes without any binder additive comprises the following steps. A coating of conductive polymer adhesives is applied on the current collector. The carbon felts are placed/positioned on either side of the current collector to achieve an assembly of carbon felts and current collector. The assembly comprises a current collector and carbon felt is placed between the plates of a hot press and processed under predetermined conditions for curing the adhesive applied on the surface of current collector for promoting/increasing a bonding between current collector and carbon felts to obtain a sandwich structure of electrode. The sandwich structure of electrode is subjected to a pressure under a roller and pressed depending on a required thickness and porosity of the carbon felt based electrodes. The electrodes are cut into desired shape using an electrode cutting die by a tailoring process.

According to one embodiment herein, the predetermined conditions for curing the adhesive applied on the surface of current collector in hot press are pressure and temperature. The predetermined applied pressure is in a range of 0.1 MPa-200 MPa. The predetermined temperature in hot press is in a range of 25° C.-200° C. The hot press reduces the thickness of the carbon felts to 5%-25% of the original value.

According to one embodiment herein, the metal current collector, imparts a mechanical strength to the carbon felt based electrodes. The metal current collectors are designed to withstand against pressure, and to achieve an enhanced current collection capacity of the carbon felt based electrodes. The current collectors are fabricated from metals selected from a group consisting of aluminum, silver, nickel, gold, iron, platinum and alloys. A structural form of current collectors is selected from a group consisting of mesh, screen, foil, foam, perforated metallic sheet, non-woven metal fiber.

According to one embodiment herein, the conductive polymer adhesives are selected from a group consisting of carbon nanotube (CNT) based adhesives, carbon-black based adhesives, silver paste, electrically conductive epoxy and meal-nanoparticles based adhesives. The conductive polymer adhesives provide an enhanced bonding between the metal current collector and the carbon felts.

According to one embodiment herein, the rolling technique for the fabrication of the carbon felt based electrode is selected from a group consisting of a hot rolling process and a cold rolling process. The rolling process/technique optimizes thickness of the carbon felt based electrodes in a range of 0.4-5 mm, and wherein the rolling process/technique optimizes porosity of the carbon felt based electrodes in a range of 5-150 μm. The rolling process/technique optimizes a density of the carbon felt based electrodes in a range of 0.3 g/cm³-2 g/cm³.

According to one embodiment herein, the fabricated carbon felt based electrodes illustrate an enhanced flexibility and mechanical robustness as compared to binder based carbon felt based electrodes. The bonding between carbon felts and metallic current collector leads to high power output.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a flow chart explaining a method of fabricating carbon felt based electrodes without any binder additive, according to one embodiment herein.

FIG. 2 illustrates an exploded assembly view of a carbon felt based electrodes assembly, according to one embodiment herein.

The features of the present invention are described in drawings and of which a few are not shown in all. These features can be combined with any or all other features that exist in the present invention.

### DETAILED DESCRIPTION OF THE EMBODIMENTS

In the following detailed description, reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide carbon felts-based electrode assembly in which a metal current collector is incorporated between two carbon felts for mechanical support. The embodiments of the present invention provide a method for fabricating carbon felts based electrodes assembly with a capacity to withstand the high pressure, improved current collection efficiency of the electrodes and thereby reducing a fraction of energy lost in a form of ohmic losses. The embodiments herein also provide a method of fabricating carbon felt based electrodes without any binder additive.

According to one embodiment herein, a method of fabricating carbon felt based electrodes without any binder additive comprises the following steps. A coating of conductive polymer adhesives is applied on the current collector. The carbon felts are placed/positioned on either side of the current collector to achieve an assembly of carbon felts and current collector. The assembly comprises a current collector and carbon felt is placed between the plates of a hot press and processed under predetermined conditions for curing the adhesive applied on the surface of current collector for promoting/increasing a bonding between current collector and carbon felts to obtain a sandwich structure of electrode. The sandwich structure of electrode is subjected to a pressure under a roller and pressed depending on a required thickness and porosity of the carbon felt based electrodes. The electrodes are cut into desired shape using an electrode cutting die by a tailoring process.

According to one embodiment herein, the predetermined conditions for curing the adhesive applied on the surface of current collector in hot press are pressure and temperature. The predetermined applied pressure is in a range of 0.1 MPa-200 MPa. The predetermined temperature in hot press is in a range of 25° C.-200° C. The hot press reduces the thickness of the carbon felts to 5%-25% of the original value.

According to one embodiment herein, the metal current collector, imparts a mechanical strength to the carbon felt based electrodes. The metal current collectors are designed to withstand against pressure, and to achieve an enhanced current collection capacity of the carbon felt based electrodes. The current collectors are fabricated from metals selected from a group consisting of aluminum, silver, nickel, gold, iron, platinum and alloys. A structural form of current collectors is selected from a group consisting of mesh, screen, foil, foam, perforated metallic sheet, non-woven metal fiber.

According to one embodiment herein, the conductive polymer adhesives are selected from a group consisting of carbon nanotube (CNT) based adhesives, carbon-black based adhesives, silver paste, electrically conductive epoxy and meal-nanoparticles based adhesives. The conductive polymer adhesives provide an enhanced bonding between the metal current collector and the carbon felts.

According to one embodiment herein, the rolling technique for the fabrication of the carbon felt based electrode is selected from a group consisting of a hot rolling process and a cold rolling process. The rolling process/technique optimizes thickness of the carbon felt based electrodes in a range of 0.4-5 mm, and wherein the rolling process/technique optimizes porosity of the carbon felt based electrodes in a range of 5-150 μm. The rolling process/technique optimizes a density of the carbon felt based electrodes in a range of 0.3 g/cm³-2 g/cm³.

According to one embodiment herein, the fabricated carbon felt based electrodes illustrate an enhanced flexibility and mechanical robustness as compared to binder based carbon felt based electrodes. The bonding between carbon felts and metallic current collector leads to high power output.

According to one embodiment herein, the whole process of fabricating carbon felt based electrodes without any binder comprises of the following steps. The first step comprises applying a coating of conductive polymer or adhesive on the current collector. The second step comprises placing the carbon felts on either side of the current collector. The third step comprises placing the whole assembly between the plates of a hot press and pressure is applied to it for curing purposes of the adhesive applied on current collector. The pressure applied is in a range of 0.1 MPa to 200 MPa. The pressure is applied at a temperature range of 25° C.-200° C. The curing ensures a strong bonding between the carbon felts and the current collector. After curing the sandwich structure is rolled through a roller at a predetermined pressure depending on the required thickness and porosity of the electrode. In the last step called tailoring process—the electrodes are cut into the desired shape using a die as per the plurality of applications.

According to one embodiment herein, the carbon felt based electrodes comprises metal current collector, carbon felts and conductive adhesive.

According to one embodiment herein, metal current collector are incorporated in carbon felt based electrodes to impart mechanical strength/sturdiness. The enhanced mechanical strength in the carbon felt based electrodes withstands against high pressure, enhances current collection capacity of the electrodes and reduces the fraction of energy lost in the form of ohmic loss.

According to one embodiment herein, the current collectors are selected from a structural forms selected from a group consisting of mesh, screen, foil, foam, perforated metallic sheet, non-woven metal fiber. The current collectors are fabricated from the metals selected from a group consisting of aluminum, silver, nickel, gold, iron, platinum and their alloys.

According to one embodiment herein, the conductive polymer adhesives are selected from a group consisting of carbon nanotube (CNT) based adhesives, carbon-black based adhesives, silver paste, electrically conductive epoxy and metal-nanoparticles based adhesives. The aforementioned conductive polymer adhesives provide strong bonding between the metal current collector and the carbon felts. Further there is enhanced conductivity which ensures less charge transfer resistance between the carbon felts and metal current collector.

According to one embodiment herein, the conductive polymer adhesives are polymer based. The typical conductive polymer adhesive comprises of a matrix of polymer, which vary across thermostat, elastomer or thermoplastic and comprise conductive fillers such as metal flakes, metal nanoparticles or any conductive carbon allotrope including carbon black, carbon nanotubes and graphene.

According to one embodiment herein, the carbon felts or graphene felts are synthesized by a known protocol by applicant in the Indian Provisional Patent Application with serial number 201811043051, filed on Nov. 16, 2018, with the title, “Methods for the Preparation of Graphene Felts”.

According to one embodiment herein, the binder-free graphene felts are synthesized from the graphene material selected from a group consisting of carbon foam, expanded graphite, exfoliated graphite, graphene sheets, graphene ribbons, graphene platelets, graphene foam, graphene sponge, graphene aerogel, graphene 3D architecture, highly expanded graphite, cross-linked graphene sheets, graphene onions, and graphene balls and their derivatives.

According to one embodiment herein, the graphene felts are synthesized by deagglomeration of the graphene materials followed by molding of the graphene felts/carbon felts.

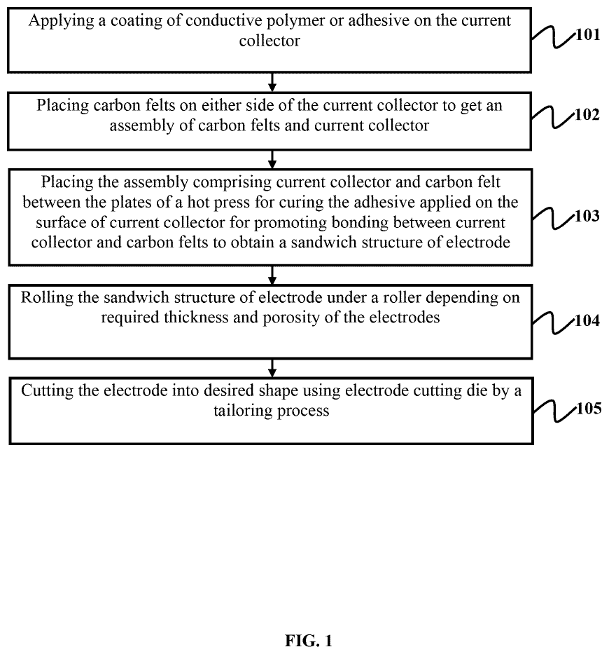

FIG. 1 illustrates a flow chart explaining a method of fabricating carbon felt based electrodes without any binder additive, according to one embodiment herein. A coating of conductive polymer adhesives on the current collector is applied (101). The carbon felts are placed on either side of the current collector to get an assembly of carbon felts and current collector (102). The assembly comprising current collector and carbon felt is placed between the plates of a hot press for curing the adhesive applied on the surface of current collector for promoting bonding between current collector and carbon felts to obtain a sandwich structure of electrode (103). The sandwich structure of electrode is rolled under a roller depending on required thickness and porosity of the electrodes (104). The electrodes are cut into desired shape using electrode cutting die by a tailoring process (105).

According to one embodiment herein, the pressing technique is used to fabricate the carbon felt based electrodes, wherein the current collector is sandwiched between two carbon felts.

According to one embodiment herein, the pressing technique is one out of hot pressing, cold pressing, hydraulic compression which reduces the thickness of the carbon felt to 5-25% of the original value.

According to one embodiment herein, the rolling technique for the fabrication of the carbon felt based electrode is selected from a group consisting of hot rolling and cold rolling. The rolling technique is performed using two high rolling mills, three high rolling mills or two reversible rolling mills.

According to one embodiment herein, the rolling technique optimizes the thickness of carbon felt based electrodes in a range of 0.4 mm-5 mm. The rolling technique optimizes the porosity of carbon felt based electrodes in a range of 5-150 μm, where this tunable porosity is applicable to fuel cell, metal air and redox flow batteries for efficient catalytic reaction. The density of the carbon felts based electrodes after subjecting to rolling technique/process is in a range of 0.3 g/cm³-2 g/cm³.

According to one embodiment herein, the carbon felt based electrodes have a tunable surface morphology where this tunable morphology is relevant to fuel cell, metal-ion, metal air and redox flow batteries for efficient electron mobility and current collection ability.

According to one embodiment herein, a tailoring process is used to give a predetermined shape to the carbon felt based electrodes. The cutting die mould is used for tailoring process.

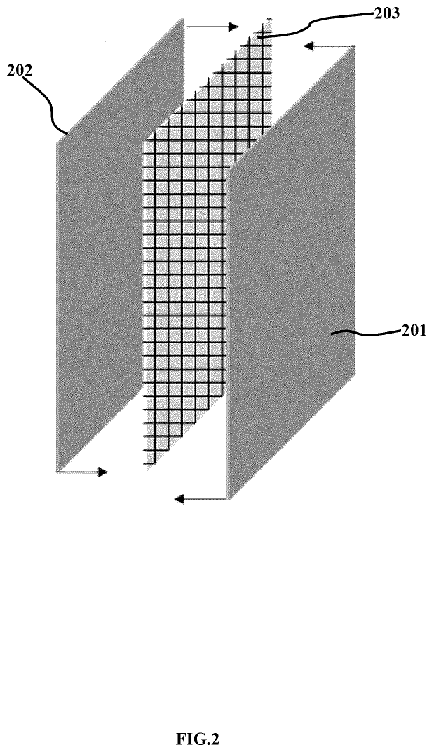

FIG. 2 illustrates an exploded assembly view of a carbon felt based electrodes assembly, according to one embodiment herein. FIG. 2 illustrates current collector (203) in between the carbon felts (201 and 202) respectively. A coating of conductive polymer adhesives is applied on the surface of current collector (203). The coating of conductive polymer adhesives is applied for promoting bonding between current collector (203) and carbon felts (201 and 202).

According to one embodiment herein, methods are provided to prepare carbon felt based electrodes from various carbon-based materials which are at least one out of carbon foam, expanded graphite, exfoliated graphite, graphene foam, Graphene 3D architecture, 3D graphene, graphene sheets, graphene platelets, activated carbon, single and multi-walled carbon nanotubes, carbon black and their derivatives.

According to one embodiment herein, the prepared carbon felt based electrode illustrates high flexibility and mechanical robustness as compared to other carbon felt electrodes that are binder based and brittle in nature.

According to one embodiment herein, the carbon felt based electrodes have excellent current collection ability. Also, the electrodes involve strong bond formation with various forms of current collectors such as metallic mesh, metallic screen, metallic foil, metallic foam, perforated metallic sheet, non-woven metal fiber and conducting polymers.

According to one embodiment herein, the carbon felt based electrodes involve strong bonding between carbon felts and metallic current collectors. The strong bonding leads to high power output due to this synergistic current collection ability of carbon felt and metallic current collector.

According to one embodiment herein, the carbon felt based electrode shows high specific surface area, controllable surface morphology, tunable pore structure that leads to high current collection property, very high conductivity, which ultimately leads to high energy and power output, that is applicable to various energy storage and harvesting applications such as fuel cell, metal-air battery, metal-ion battery, supercapacitors and redox flow batteries etc.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope.

Although the embodiments herein are described with various specific embodiments, it will be obvious for a person skilled in the art to practice the embodiments herein with modifications. Although the embodiments herein are described with various specific embodiments, it will be obvious for a person skilled in the art to practice the embodiments herein with modifications.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims submitted below. The scope of the invention will be ascertained by the following claims.

What is claimed is:

1. A method of fabricating carbon felt based electrodes without any binder additive, the method comprising steps of:
applying a coating of conductive polymer adhesives on the current collector;
placing/positioning carbon felts on either side of the current collector to obtain an assembly of carbon felts and current collector;
placing the assembly comprising current collector and carbon felt between the plates of a hot press with predetermined conditions for curing the adhesive applied on the surface of current collector, and wherein the hot press promotes bonding between current collector and carbon felts to obtain a sandwich structure of electrode;
rolling the sandwich structure of electrode under a roller depending on required thickness and porosity of the carbon felt based electrodes; and
cutting the electrode into desired shape using an electrode cutting die by a tailoring process.

2. The method according to claim 1, wherein the predetermined conditions for curing the adhesive applied on the surface of current collector in hot press are pressure and temperature, and wherein the pressure applied is in a range of 0.1 MPa-200 MPa, and wherein the temperature in hot press is in a range of 25° C.-200° C., and wherein the hot press reduces the thickness of the carbon felts to 5%-25% of the original value.

3. The method according to claim 1, wherein the metal current collector, imparts mechanical strength to the carbon felt based electrodes, and wherein the metal current collectors withstand against pressure, enhances current collection capacity of the carbon felt based electrodes, and wherein the current collectors are fabricated from metals selected from a group consisting of aluminum, silver, nickel, gold, iron, platinum and alloys, and wherein a structural form of current collectors is selected from a group consisting of mesh, screen, foil, foam, perforated metallic sheet, non-woven metal fiber.

4. The method according to claim 1, the conductive polymer adhesives are selected from a group consisting of carbon nanotube (CNT) based adhesives, carbon-black based adhesives, silver paste, electrically conductive epoxy and meal-nanoparticles based adhesives, and wherein the conductive polymer adhesives provide enhanced bonding between the metal current collector and the carbon felts.

5. The method according to claim 1, wherein the rolling technique for the fabrication of the carbon felt based electrode is selected from a group consisting of hot rolling and cold rolling, and wherein rolling process/technique optimizes thickness of the carbon felt based electrodes in a range of 0.4-5 mm, and wherein the rolling process/technique optimizes porosity of the carbon felt based electrodes in a range of 5-150 μm, and wherein the rolling process/technique optimizes density of the carbon felt based electrodes in a range of 0.3 g/cm³-2 g/cm³.

6. The method according to claim 1, wherein the fabricated carbon felt based electrodes illustrate an enhanced flexibility and mechanical robustness as compared to binder based carbon felt based electrodes, and wherein a bonding between carbon felts and metallic current collector leads to high power output.
